(19) United States
(12) Patent Application Publication
(10) Pub. No.: US 2007/0130233 A1
(43) Pub. Date: Jun. 7, 2007

(54) Representing media as folders in backup systems

(76) Inventor: Rodney A. Christensen, Fresno, CA (US)

Correspondence Address: COURTNEY STANIFORD & GREGORY LLP, P.O. BOX 9686, SAN JOSE, CA, 95157, US

(21) Appl. No.: 11/599,746

(22) Filed: Nov. 14, 2006

Related U.S. Application Data
(60) Provisional application No. 60/737,055, filed on Nov. 14, 2005.

(51) Int. Cl. G06F 17/30

(52) U.S. Cl. 707/204

(57) ABSTRACT

Embodiments are directed to a network backup system (NBS) that supports numerous backup policies or schemes for controlling backup jobs and corresponding copy jobs in accordance with media object associations. The media object associations include logical associations between media (represented by media folders) and media objects (representing related media in a backup process). The NBS forms the logical associations as a result of placing the media objects in the media folders during backup processes. Through the use of these media objects the NBS automatically controls the retention and reuse of backup files/data of virtual and/or physical media according to information of the media object associations. The NBS uses the media object associations to provide a network backup policy that integrates optimum retention of backup data with efficient use/reuse of backup media. In addition, the NBS optimizes the retention and reuse of virtual media and the disk storage used to store their content.

### CROSS-REFERENCE TO RELATED APPLICATIONS

The present applications claims the benefit under 35 U.S.C. § 119 of the U.S. Provisional Application No. 60/737,055, entitled “Representing Media as Folders in Backup Systems,” and filed on Nov. 14, 2005.

### TECHNICAL FIELD

Embodiments relate generally to computer systems, and more particularly to data backup systems.

### BACKGROUND

A data backup and recovery system is an integral component of data security in a company or network environment. The ability to efficiently and quickly backup and restore data critical to company business is an important part of the day-to-day operations of a company. Backup of data however is often a tedious and cumbersome process that, without the right systems in place, can become very burdensome. Consequently, there is a need for a data backup and recovery system that provides reliable, efficient and safe data backup and recovery.

The representation of data to be backed up in a graphical user interface is often an important factor in determining the ease of use and efficiency of the backup process. Requiring users to execute dedicated scripts or programs, or navigate through complex menu structures in order to perform backup operations to disk or other media can discourage use, and therefore limit the efficacy of backup programs. It is desirable, therefore, to provide a backup system that facilitates ease of use through logical graphical user interface functionality.

### BRIEF DESCRIPTION OF THE FIGURES

Embodiments are illustrated by way of example and not limitation in the figures of the accompanying drawings, in which like references indicate similar elements and in which:

FIG. 1 is a block diagram of a network that includes the Network Backup System (“NBS”), under an embodiment.

FIG. 2 is an example backup catalog including a backup job (“Backup Job”), under an embodiment.

FIG. 3 is an example backup catalog including the Backup Job along with virtual media (Tape 1) resulting from execution of the Backup Job, under an embodiment.

FIG. 4 is an example backup catalog including a hierarchy of folders, under an embodiment.

FIG. 5 is an example backup catalog showing expansion of media folder Tape 1, under an embodiment.

FIG. 6 is an example backup system that includes a backup catalog and a media pool under a D2D2D2CD backup, under an embodiment.

FIG. 7 is an example backup system that includes the backup catalog and media pool following movement of a media object from the backup catalog for long-term preservation, under an embodiment.

### INCORPORATION BY REFERENCE

Each publication, patent, and/or patent application mentioned in this specification is herein incorporated by reference in its entirety to the same extent as if each individual publication and/or patent application was specifically and individually indicated to be incorporated by reference.

### DETAILED DESCRIPTION

A Network Backup System (“NBS”) is disclosed that supports numerous backup policies or schemes for controlling backup jobs and corresponding copy jobs in accordance with media object associations. The media object associations include logical associations between media (represented by media folders) and media objects (representing related media in a backup process). The NBS forms the logical associations as a result of placing the media objects in the media folders during backup processes. Through the use of these media objects the NBS automatically controls the retention and reuse of backup files/data of virtual and/or physical media according to information of the media object associations. The NBS uses the media object associations to provide a network backup policy that integrates optimum retention of backup data with efficient use/reuse of backup media. In addition, the NBS optimizes the retention and reuse of virtual media and the disk storage used to store their content.

The NBS of an embodiment uses a media folder to represent a first backup media, where the media folder is a folder into which objects or contents may be placed. As a folder, the media folder may contain other media, each of which is represented by additional media objects. Thus, use of the media folder, which is both a media object and a folder/container in contrast to typical backup systems using files, allows one or more additional copies of backup media to be associated with the first backup media through placement in the media folder. Thus, for example, the NBS allows users to create a restore job that restores data from “Tape 1” even though Tape 1 in the catalog is a folder (i.e., allows users to read data from a folder while also allowing the folder to contain other objects).

Placement of an object into the media folder forms a logical association between the media represented by the folder and the contents of the folder. The NBS uses information of this logical association in managing the use/reuse of media and in so doing prevents reuse of media represented by objects in the folder until such time as the media represented by the folder has been reused. Further, the media folders allow users to easily view all backup media present in the network along with the contents of the backup media organized according to host media.

As an example, the NBS may control a disk-to-disk-to-tape backup process in which selected files are backed up from their respective network locations (“disk . . . ”) to virtual media (“ . . . -to-disk . . . ”) and to physical media (“ . . . -to-tape”). The disk-to-disk portion of the backup replicates the selected files from their respective network locations to virtual media in the form of a backup hard disk for example. The NBS creates a media object, which in this example is also a media folder, to represent the virtual media. The disk-to-tape portion of the backup copies the selected files to physical media in the form of a Compact Disk (“CD”) for example. The NBS creates a media object to represent the physical media and places the media object of the physical media in the media folder of the virtual media. At this point, the selected files exist on two pieces of media in the system, the virtual tape “folder” and the CD; files may be restored from at least one of the two pieces of media.

Placement of the media object representing the physical media in the media folder of the virtual media forms a logical association between the virtual and physical media. Regardless of what subsequently happens to the virtual media (e.g., data removed, data overwritten to free disk space, etc.) the media folder continues to logically include the physical media to which the data was written. If the virtual media is subsequently overwritten, then the physical media will become free for reuse. However, if the data in the virtual media is removed to free disk space (similar to a caching scheme), then the physical media is retained in the folder and remains ineligible for reuse. Thus, the physical media object includes a copy of the data written to the virtual media regardless of whether the virtual media still retains the data.

At such time as the backup policy of the host network permits overwriting of the virtual media, the NBS identifies that the physical media is associated with the virtual media by its presence in the media folder. Therefore, when the NBS overwrites the virtual media, and because the physical media is in the virtual media folder, the NBS determines retention of the physical media is no longer required under the backup policy. The physical media is thus removed from the media folder and returned to a free pool (referred to as a “media pool”) where the NBS may subsequently reuse the physical media.

In the following description, numerous specific details are introduced to provide a thorough understanding of, and enabling description for, embodiments of the NBS. One skilled in the relevant art, however, will recognize that these embodiments can be practiced without one or more of the specific details, or with other components, systems, etc. In other instances, well-known structures or operations are not shown, or are not described in detail, to avoid obscuring aspects of the disclosed embodiments.

The NBS generally provides the ability to backup and restore data files. Data that cannot be reloaded onto the system from installation disks and/or databases should be backed up for easy retrieval in the event of a data disaster. The data may include for example network user information, word processing files, and other data critical to business operations.

Backup operations as referenced herein include the process of copying a file or folder from its current location to a new location. The new location includes media coupled to the host network, where the media (also referred to as “backup media”) can be any type of media in any type of device as appropriate to write and read operations to the media. The original data remains intact and in its current location in the network system during backup operations. The NBS of an embodiment supports numerous backup modes including but not limited to full backup mode, differential backup mode, incremental backup mode, and copy mode.

Restore operations as referenced herein include the process of copying data from backup media to its original location or to a new location in the network system in the event the original location is damaged or unavailable. Restore operations can also retrieve data to a file or folder other than the original one. The NBS of an embodiment supports numerous restore modes.

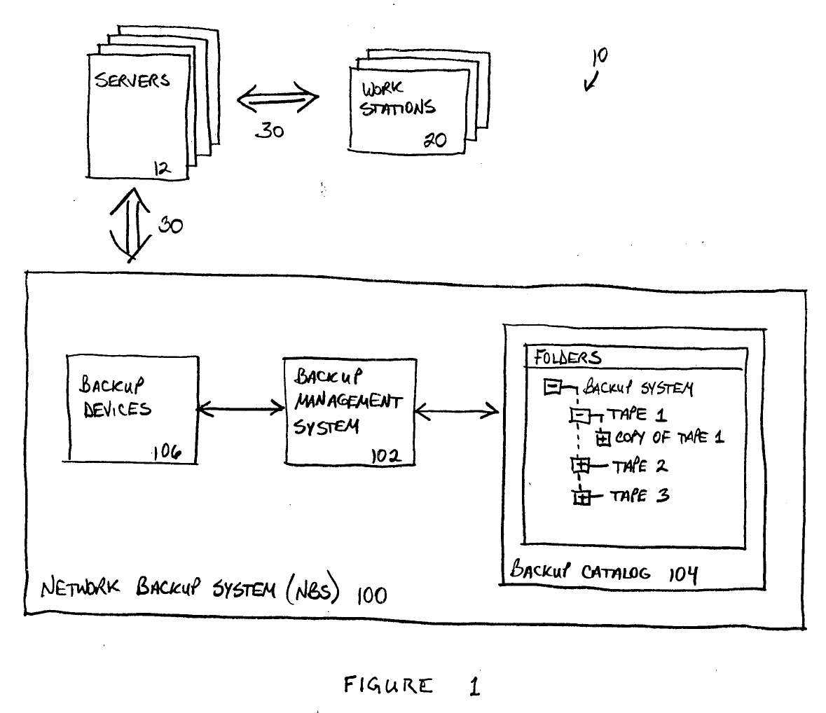

FIG. 1 is a block diagram of a network 10 that includes the NBS 100, under an embodiment. The network 10 includes one or more servers 12 coupled to any number of workstations 20 using a local area network (“LAN”) 30 or other network type. The NBS 100 is coupled to the servers 12 and/or the work stations 20 using the LAN 30. The NBS 100 is a complete backup system that includes a backup management system or program 102 along with a backup catalog 104 and one or more backup devices 106.

The backup management system 102 of an embodiment is an application program that writes files to the backup media via the backup devices 106. The backup management system 102 also manages the backup catalog 104. Writing files to backup media includes creating and running jobs, such as backup jobs, copy jobs and restore jobs, which transfer files back and forth between backup devices and file or application servers or computer desktops. The backup management system 102 of an embodiment supports numerous types of backups (e.g., full backups, incremental backups, differential backups) under any number of media rotation schemes.

The backup devices 106 may include any number and/or type of device for writing data to and reading data from media. The backup devices 106 receive the media (not shown) as appropriate to the backup devices 106. The backup devices 106 may include tape drives, hard disks, virtual libraries, virtual tape drives, Network Attached Storage (“NAS”) appliances, CD writing/recording devices, Digital Versatile Disk (“DVD”) writing/recording devices, and loader/library devices, to name a few. The media may include any type of virtual and/or physical media like tape, magnetic media, optical media, as well as other media types known in the art. The physical media currently available for use in backup operations is generally held in a “media pool” (not shown).

The backup management system 102 generates and manages a backup catalog 104, also referred to as the storage management catalog 104. The backup catalog 104 keeps track of used and available backup media. The backup catalog 104 also keeps track of each file stored on the backup media and ensures security of the files. For each media, the backup catalog 104 includes detailed information about the media such as when the media was created and identification of the user who created the media. The backup catalog 104 also includes detailed information about files on the media, where the information includes when the files were backed up and on which media files are stored. Further, the backup catalog 104 includes configuration information, backup jobs, restore jobs, media, objects representing backed up files to name a few.

The backup management system 102 manages the backup catalog 104 using “objects,” “properties,” and “storage management domains.” As such, the backup catalog 104 collects and organizes information about objects. An object is any file, machine, device, backup media, and/or user about which the NBS stores data. Examples of objects tracked using the backup catalog 104 include backup media, tape drives, network servers, versions of files, backup jobs, custom templates, and users to name a few.

Objects of an embodiment may also include other objects. A “media folder” and/or other folder is an example object that is a folder. This folder may contain other objects within it, such as jobs, files, templates, user information, etc. The NBS also displays information about the contents of objects other than folders. Therefore, a user viewing a list of contents of the storage management domain for example may see objects that include machines, networks, devices, and libraries. Although not folders, these objects may contain other objects; for example, a library can contain storage slots and import/export slots. Further, a network may contain file systems, network drives, printers, and attached backup devices.

As an example, with reference to FIG. 1, the backup catalog 104 of an embodiment has a network backup system folder (“BACKUP SYSTEM”) that includes three (3) objects in the form of media folders (“TAPE 1”, “TAPE 2”, “TAPE 3”). The expanded contents of the TAPE 1 media folder show it to include a single media folder “COPY OF TAPE 1”.

Each object in the backup catalog of an embodiment includes information referred to as “properties”. The properties include information of the object like the kind/type of object, users having permissions to use the object, and any relationships with other objects, to name a few. As one example, an individual backup media is an object in the backup catalog. The properties of that media stored in the catalog include the name, when the media was created, users having security permissions to use the media, and information about whether the media can be erased, but may include other information as appropriate to the media.

The backup management system of an embodiment may support one or more backup catalogs. On a large network it may be useful for example to have multiple catalogs, each addressing different data protection needs. In an embodiment, each “domain” or “zone” uses a single catalog, but a network may include two or more domains or zones. For example, there may be a separate catalog for each work group or department, even though they are all on the same network. The storage management domains allow users to select a catalog for use among the catalogs of the network as appropriate to the domain into which the user is logged.

A user of the NBS transfers files between backup devices and network computers coupled to the network by creating and running “jobs”. The jobs include for example “backup jobs” and “restore jobs” but are not limited to these two job types. The jobs once created are stored in folders as described above. The NBS, under control of backup jobs, generates backup media by backing up or copying network files of servers and/or computers onto virtual and/or physical media via the backup devices. The NBS subsequently uses “restore jobs” to restore files on the network servers and/or computers using files of the backup media.

A backup job copies selected files from network computers like file or application servers and personal computers (“PC”). The selected files are copied to backup media that may include tapes, writable CD media, writable DVD media, and virtual media for example. These backup media are subsequently stored thereby preserving a copy of the files for future use. The process for creating a backup job allows a user to select the contents of individual files and/or folders for backing up; selection of an item automatically selects every item included in or under the selected item. The backup job also identifies backup devices and locations in the network system to which backup files can be written for storage. Additionally, the backup job identifies the media to which the backup files are written.

The NBS of an embodiment stores a backup job inside a folder, where the folder may be one or more of a “user/group folder”, a “job folder”, a “media folder”, or any other folder type. User/group folders are stored in a “home folder” of the host network system. The user/group folders may contain job folders and/or media folders. Additionally, user/group folders may contain “loose” jobs or media.

Job folders can be stored in user/group folders and/or in other job folders. The job folders contain jobs and/or additional job folders. Media folders can be stored in user/group folders and/or in other media folders. The media folders contain media and/or additional media folders.

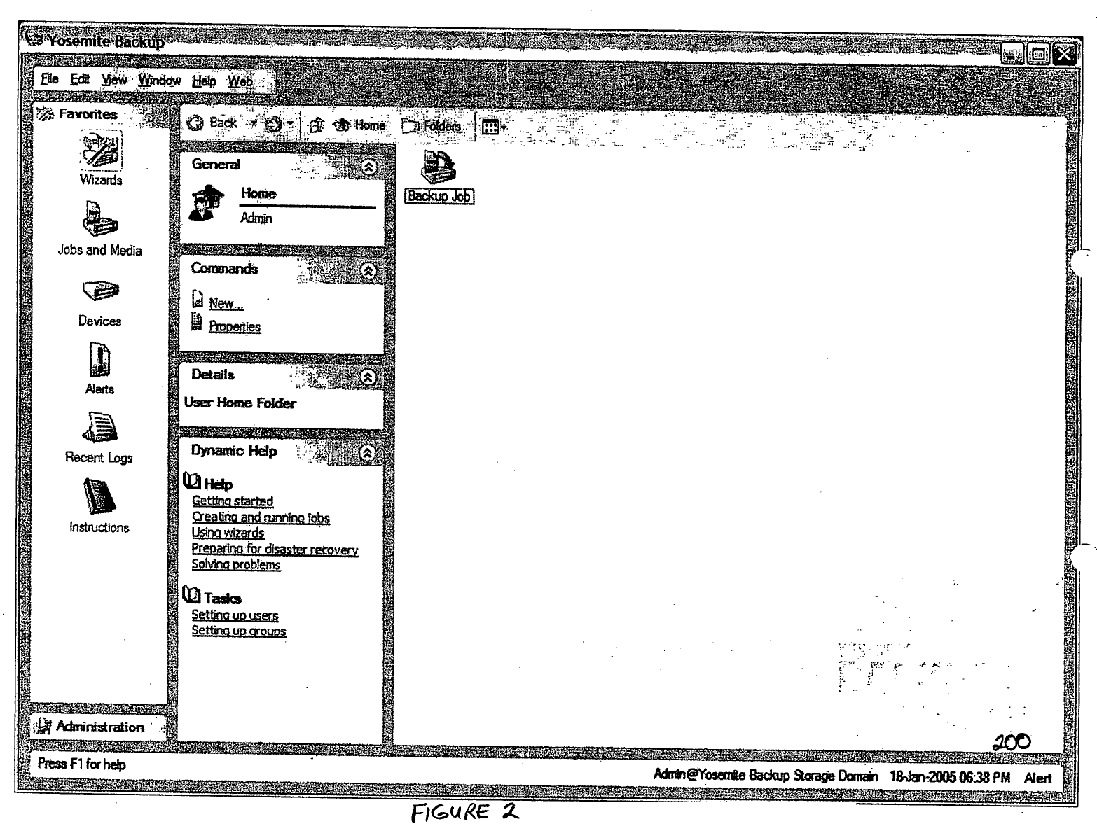

The NBS of an embodiment supports numerous backup schemes by controlling backup jobs and corresponding copy jobs in accordance with media object associations. The media object associations include media folders into which the backup management system places objects or contents representing related media of a backup process. An example of a backup job under the backup management system follows, with reference to FIGS. 2-5, to show use of the media folder object. The backup job of this example is configured to backup selected files using a “disk-to-disk-to-tape” backup process (referred to as “D2D2T”). The D2D2T backs up selected files of network systems (“disk . . . ”) to virtual media (e.g., hard disk) (“ . . . -to-disk . . . ”) and to physical media (e.g., tape, CD, DVD) (“ . . . -to-Tape”) for example, but is not so limited.

The backup job begins with a user creating a “Backup Job” by specifying the parameters of the backup process (e.g., selected files for backup, backup media, backup devices, backup schedule, backup rotation, etc.). Simultaneous with or subsequent to creation of the Backup Job, the backup management system executes the D2D2T Backup Job as appropriate to parameters of the Backup Job. Execution of the Backup Job results in writing of the files selected for backup to a selected hard disk, and the hard disk is represented in the catalog with the Tape 1 media folder. The Backup Job also creates a “Copy Tape 1” copy job and places the Copy Tape 1 object in the Tape 1 media folder. Execution of the Copy Tape 1 copy job copies all files from Tape 1 to selected physical media (“Copy of Tape 1”). The physical media is represented in the catalog with the Copy of Tape 1 object in the Tape 1 media folder.

This is in contrast to typical backup systems in which Tape 1 and Copy of Tape 1 are two separate media objects (media objects are not folders in these typical systems) and there is no association of Tape 1 to Copy of Tape 1. Therefore, when Tape 1 is overwritten in these typical systems there is no way to indicate or know that Copy of Tape 1 may now be overwritten. Thus, the reuse of Copy of Tape 1 may not occur or, if it does occur, may be controlled by an unrelated process.

The example begins with creation of the Backup Job. FIG. 2 is an example of backup catalog contents 200 including a backup job (“Backup Job”), under an embodiment. This user (“Administration”) “Home Folder” view shows the catalog 200 as including the Backup Job object. Thus, following creation of the Backup Job, the backup management system of an embodiment places the Backup Job in the catalog 200 where information of the Backup Job may be viewed using the Home Folder.

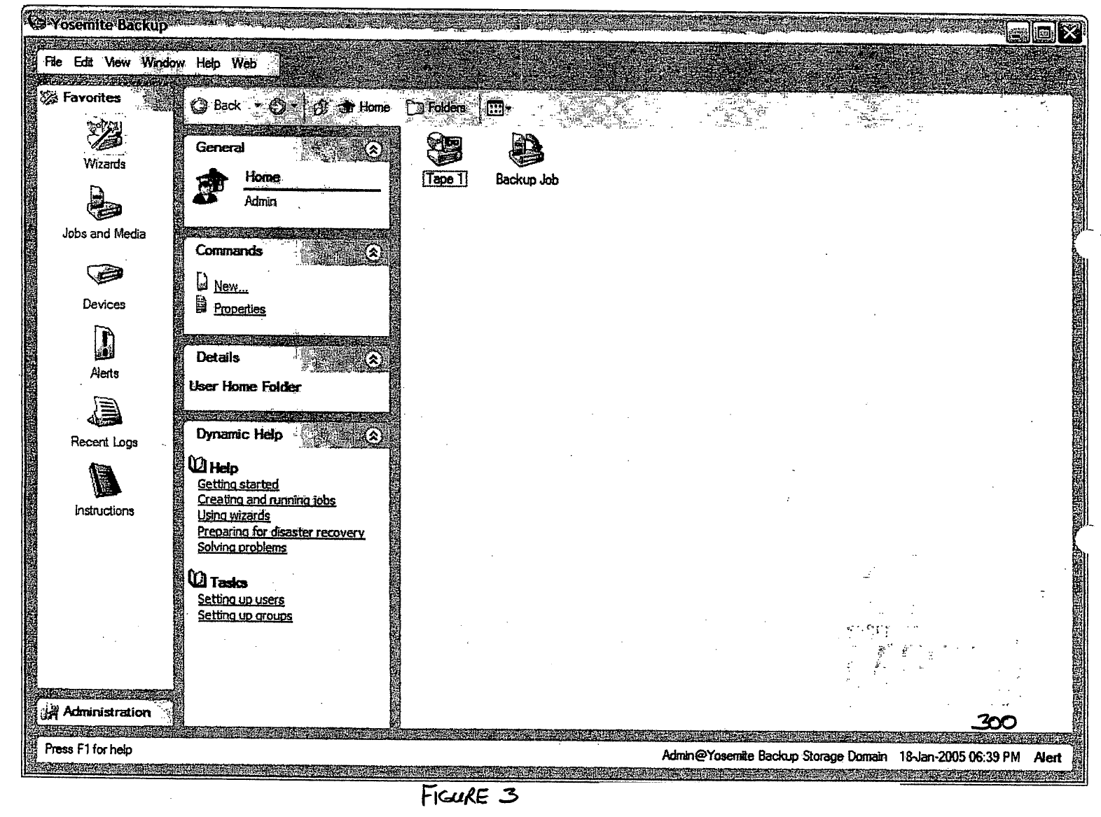

Simultaneous with or subsequent to creation of the Backup Job, the backup management system executes the D2D2T Backup Job as appropriate to parameters of the Backup Job. The D2D2T Backup Job parameters of an embodiment are split between the backup job and the virtual library device but are not so limited. As such, the Backup Job selects the virtual library for the backup, and the virtual library is configured, under policies, to automatically copy the media to another media. Execution of the Backup Job results in writing of the files selected for backup to a selected hard disk of the host network system, and the hard disk is represented in the catalog with the “Tape 1” media folder. FIG. 3 is an example of backup catalog contents 300 including the Backup Job along with the virtual media (Tape 1) resulting from execution of the Backup Job, under an embodiment. In this example, the data backed up during execution of the Backup Job is stored in virtual media represented as media folder object Tape 1. Consequently, Tape 1 is an object in the catalog 300 representing the virtual media (e.g., network hard disk storage device) that is shown along with the Backup Job object.

As described above, the Backup Job also creates a “Copy Tape 1” copy job and places the Copy Tape 1 object in the Tape 1 media folder. Execution of the Copy Tape 1 copy job copies all files from Tape 1 to selected physical media (“Copy of Tape 1”). The physical media is represented in the catalog with the Copy of Tape 1 object in the Tape 1 media folder.

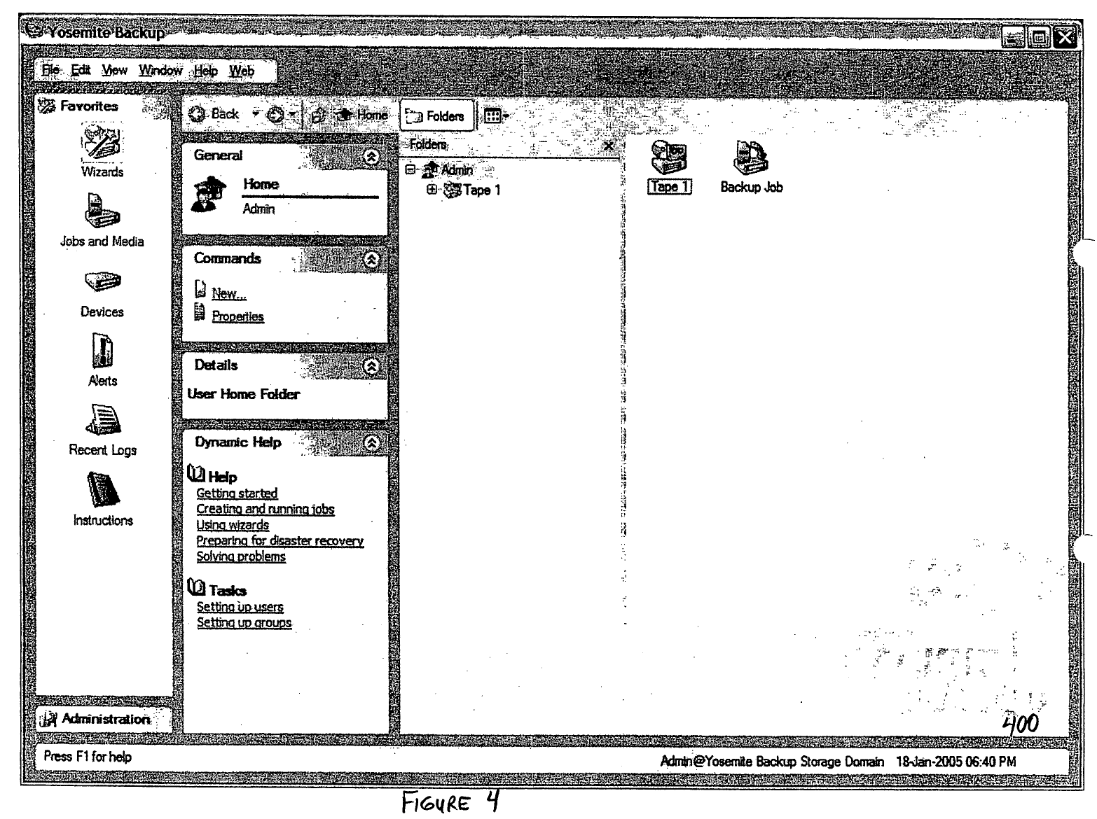

FIG. 4 is an example of backup catalog contents 400 showing a hierarchy of folders including media folder Tape 1, under an embodiment. Folder Tape 1 represents the virtual media that includes files backed up during the Backup Job. This folder view of backup catalog contents 400 shows that Tape 1 is a folder, where the “+” box corresponding to Tape 1 allows the user to expand the Tape 1 folder to view any subfolders or objects in the folder.

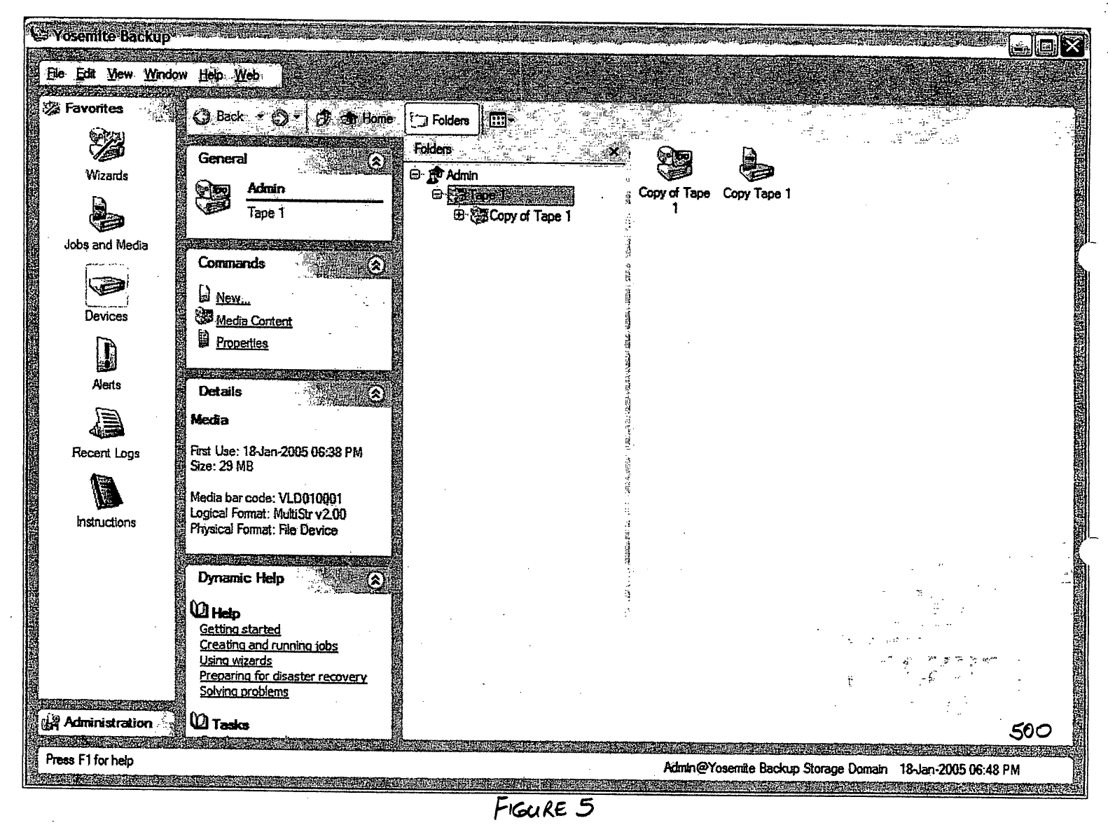

The user may view the objects representing the backup media in the catalog by expanding the Tape 1 folder. FIG. 5 is an example of backup catalog contents 500 showing expansion of media folder Tape 1, under an embodiment. Expansion of the Tape 1 folder results in the display of two objects in the Tape 1 folder: Copy of Tape 1 and Copy Tape 1. The media folder object Copy of Tape 1 represents a physical media of the media pool that contains the same data that resides on Tape 1. The media folder object Copy Tape 1 is the copy job that the backup management system automatically creates in accordance with its copy policies, as described above.

The NBS of an embodiment uses multiple copy retention policies to manage data copied from virtual media to other media (that is, from “Tape 1” to “Copy of Tape 1” in this example). The copy retention policies provide for efficient management and use of backup media like virtual media of a host system and the reuse of the disk storage holding the data in the virtual media. The copy retention policies include a policy that retains data of a second media until corresponding data of a first media is overwritten. This policy prevents for example physical media from being reclaimed until such time as it is safe to reuse the physical media.

The copy retention policies also include a policy that retains data until it is copied. Under this policy the NBS reclaims disk storage space used by the virtual media upon successful completion of the copy job that copies the data of the virtual media to physical media for example. The NBS therefore removes from the catalog the existence of objects on the virtual media. That is, if a user starts a restore job, the restore job would not find the requested files on the virtual media but would find them on the physical media.

The copy retention policies also include a policy that retains data until disk space is needed. Under this policy the NBS reclaims disk storage from virtual media that has been successfully copied to physical media under the embodiment. Therefore, the NBS leaves virtual media intact, with its data, even after the data has been copied to the physical media. Then, if the NBS exhausts space on the disk, it can reclaim space for those virtual media that have been copied to other media.

The D2D2T process described above is but an example backup process using the backup management system and backup catalog of an embodiment. The media folder/object association of the backup management system and catalog of an embodiment may be used for any number/type of backup hierarchies (e.g., D2D2T2T, D2D2D2D2DT, etc.) and is not limited to any particular backup hierarchies.

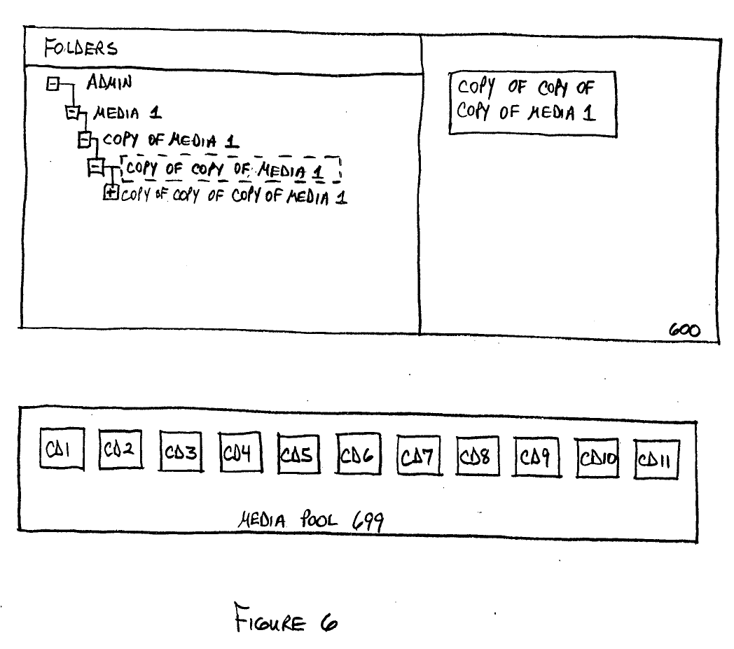

As another example backup hierarchy, the NBS of an embodiment supports a disk-to-disk-to-disk-to-CD backup (“D2D2D2CD”). FIG. 6 is an example backup system that includes a backup catalog 600 and a media pool 699 under a D2D2D2CD backup, under an embodiment. The backup catalog 600 includes a hierarchy of folders including media folder Media 1, where media folder Media 1 represents the virtual media that includes files backed up during the Backup Job (“disk-to-disk . . . ”). The subfolders under the Media 1 folder include media folder object “Copy of Media 1”, which is a first subfolder that represents virtual media containing replicated data (“ . . . -to-disk . . . ”) of Media 1. The subfolders also include media folder object “Copy of Copy of Media 1”, which is a second subfolder that represents virtual media containing replicated data (“ . . . -to-disk . . . ”) of Tape 1. Additionally, the subfolders include media folder object “Copy of Copy of Copy of Media 1”, which is a third subfolder that represents physical media containing copied data (“ . . . -to-CD”) of Media 1.

In this example the user is viewing the objects representing the backup media in the catalog 600 via an expansion of the Copy of Copy of Media 1 subfolder that displays the subfolder Copy of Copy of Copy of Media 1 (the “−” box corresponding to Copy of Copy of Media 1 shows the user has expanded the folder). This example assumes that the subfolder Copy of Copy of Copy of Media 1 includes two objects, where a first object “CD1” represents a physical media (e.g., CD) that contains a first half of the data that resides on Media 1, and a second object “CD2” represents a physical media that contains a second half of the data that resides on Media 1. The physical media CD1 and CD2 are elements of the media pool 699 available to the NBS as backup media.

As described above, the hierarchical media folder structure of the NBS represents each media via a folder object instead of a file. This media folder structure thus allows multiple additional copies of the backup media (Copy of Media 1, Copy of Copy of Media 1, and Copy of Copy of Copy of Media 1 (CD1 and CD2)) to be associated with the first backup media (Media 1) by placement of objects that represent the additional copies into the Media 1 media folder. Successive placement of these objects into the media folders forms a logical association between the media represented by the folder (Media 1) and the contents of the folder. The NBS uses information of this logical association in managing the use/reuse of media and in so doing automatically preserves each piece of media in the hierarchy until such time as the media represented by the folder (Media 1) has been reused.

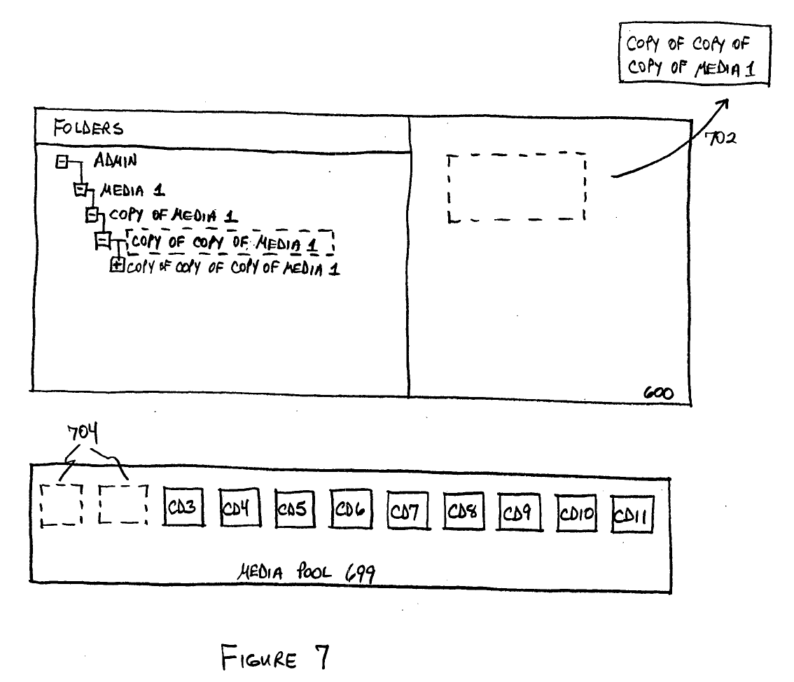

The NBS of an embodiment, through use of the media object associations, allows copies of media to readily be separated from an original media folder. FIG. 7 is an example backup system that includes the backup catalog 600 and media pool 699 following movement of a media object from the backup catalog 600 for long-term preservation, under an embodiment. In this example, and with further reference to FIG. 6, a user may navigate in the catalog user interface to the “Copy of Copy of Media 1” media subfolder. In that view, “Copy of Copy of Copy of Media 1” is visible in the details pane. The user may then click on the right mouse button on “Copy of Copy of Copy of Media 1”, select “Move” from the popup menu (not shown), navigate to another folder (such as the Home folder), and move “Copy of Copy of Copy of Media 1”to the Home Folder. Alternatively, the user may “drag” the “Copy of Copy of Copy of Media 1” subfolder from the catalog 600 and “drop” or “paste” the media folder into another system folder (not shown). Once “Copy of Copy of Copy of Media 1” is moved 702 out of “Media 1”, the NBS preserves this data from being overwritten or otherwise deleted regardless of subsequent erasure, deletion, or overwriting of “Media 1”.

Therefore, a user wishing to overwrite Media 1, but needing to preserve the data of Media 1 for a longer term, could move the copy of the data of Media 1 present on the physical media (CD1 and CD2) to another folder in the host computer system. This is because the data on Media 1 and the data on Copy of Copy of Copy of Media 1 are equally valid copies of the original data files, allowing use of either one for restorations. This process then allows Media 1 to be overwritten during a subsequent backup process, where the subsequent backup process would then backup the data of Media 1 on other media of the media pool 699, while preserving the contents of Copy of Copy of Copy of Media 1 and protecting them from being overwritten in the future.

The physical media available to the NBS for use in backup processes of an embodiment is maintained in a media pool 699, as described above. Removal 702 of media from the backup catalog 600, as with the removal of Copy of Copy of Copy of Media 1, results in removal 704 of the corresponding physical media (CD1 and CD2) from the media pool 699. Therefore, the physical media (CD1 and CD2) are eliminated from the media rotation of the backup system, thus preserving the data of this physical media.

The NBS as described herein automatically maintains and controls the safety of network data and files through the use of a backup management system that integrates tracking of both virtual and physical media into the network backup policy. The use of media folders and objects provides for this integration by automatically associating the different virtual and/or physical media that contain backup files of the same data. Using the media folders and objects, and referring to the example above, the backup management system knows that Copy of Tape 1 media object is bound to the Tape 1 media object since Tape 1 is a folder that contains Copy of Tape 1. Thus, until and unless Tape 1 is made available for reuse by the backup policies of the backup management system, the contents of Tape 1 (contents of Tape 1 folder including physical media containing Copy of Tape 1) will not be made available for reuse in any backup operations. This results in retention of physical media Copy of Tape 1 until such time as the virtual media Tape 1 is made available for reuse by the network copy policy. At such future time as Tape 1 is erased, deleted, or overwritten, the backup management system makes Copy of Tape 1 available for reuse because it is in a folder associated with Tape 1.

The NBS media folder/object association therefore provides automatic reuse of physical media only when the network backup policy allows for the reuse of the corresponding virtual media. This integration of physical media rotation into the network backup policy optimizes physical media use/reuse by automatically returning physical media to the media pool for reuse in accordance with the backup rotation scheme. The NBS also optimizes security of network data and files by automatically preventing accidental deleting or overwriting of physical media not intended for reuse.

The components of the NBS described above include any collection of computing components and devices operating together. While the embodiments described herein are described with reference to virtual media, these embodiments are not limited to virtual media and can be extended to embodiments using any type and/or combination of media. The components of the NBS can also be components or subsystems within a larger computer system or network. The NBS components can also be coupled among any number of components (not shown), for example other buses, controllers, memory devices, and data input/output (I/O) devices, in any number of combinations. Further, functions of the NBS components can be distributed among any number/combination of other processor-based components.

Embodiments of the NBS system described herein may be implemented as part of a computer backup system, such as the backup system described in the “User's Guide and Technical Reference for Yosemite Backup”, which is published by Yosemite Technologies, Inc., and which is hereby incorporated by reference in its entirety. In general, such a backup system allows the backup system to emulate a wide variety of different tape or media drive devices during the backup process. Embodiments include a process of managing media in a catalog that are related to each other because of the NBS copy process. When a user backs up a data set to a target directory the catalog tracks those file versions and associates them with a virtual media. If the user has configured a copy policy to move the data along the NBS path then the copy will create yet another media that reflects the data that was copied. The copy process is intelligent in that each object on the source media is copied and tracked on the target media just as if it had come from the source system. This allows the user to restore from either media with the same user experience. The resulting media is stored in the catalog as a child of the source media. This is significant in that when the user reuses the original source media, all children of the source media are deleted from the catalog and become available for reuse as well.

Aspects of the NBS described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the NBS include: microcontrollers with memory (such as electronically erasable programmable read only memory (EEPROM)), embedded microprocessors, firmware, software, etc. Furthermore, aspects of the NBS may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that the various NBS components and/or processes disclosed herein may be described and/or expressed (or represented), as data and/or instructions embodied in various computer-readable media, in terms of behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the NBS components and/or processes may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,”“hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the NBS is not intended to be exhaustive or to limit the NBS to the precise form disclosed. While specific embodiments of, and examples for, the NBS are described herein for illustrative purposes, various equivalent modifications are possible within the scope of the NBS, as those skilled in the relevant art will recognize. The teachings of the NBS provided herein can be applied to other processing systems and methods, not only for the systems and methods described above.

The elements and acts of the various embodiments described above can be combined to provide further embodiments. These and other changes can be made to the NBS in light of the above detailed description.

What is claimed is:

1. A method comprising:
representing a first physical media for storing data backed up from a second media as a folder in a graphical user interface into which data to be backed up may be placed; and
storing the data on the second physical media when an object representing the data is moved into the folder.

2. The method of claim 1 wherein the first physical media comprises one of the group consisting of a tape, a hard drive, a compact disk, and a digital versatile disk.

3. The method of claim 2 wherein the second physical media comprises one of the group consisting of a tape, a hard drive, a compact disk, and a digital versatile disk.

4. The method of claim 1 wherein graphical placement of the object representing the data establishes a logical association between the first physical media and the data.

5. The method of claim 4 wherein the object representing the data comprises one of the group consisting of: a file name, an icon representing a program type creating the data, and a directory folder containing the data.

6. The method of claim 1 further comprising saving the data to a virtual media prior to storing the data on the second physical media when the object representing the data is moved into the folder.

7. The method of claim 6 further comprising
saving the data to a virtual media prior to storing the data on the second physical media when the object representing the data is moved into the folder; and
creating a media folder representing the virtual media for display in the graphical user interface.

8. The method of claim 1 wherein the data is backed up in a backup operation selected from the group consisting of an incremental backup of the data, a differential backup of the data, a full backup of the data, and a copy operation of the data from the first physical media to the second physical media.

9. The method of claim 1 further comprising maintaining information about the data in a backup catalog, the backup catalog, the information including data configuration and type information, data location information, and data creation and backup time information.

10. The method of claim 1 wherein the graphical user interface is executed on a first computer coupled to a second computer over a network, and wherein the first physical media is coupled to the first computer and the second physical media is coupled to the second computer.

11. A system comprising:
a network coupling a first computer to a second computer;
a first physical media coupled to the first computer for storing data stored on a second media coupled to the second computer;
a graphical user interface executed on the first computer, and configured to display as a folder the first physical media into which the data to be backed up may be placed; and
a backup job process configured to store the data on the second physical media when an object representing the data is moved into the folder.

12. The system of claim 11 wherein the first physical media comprises one of the group consisting of a tape, a hard drive, a compact disk, and a digital versatile disk; and wherein the second physical media comprises one of the group consisting of a tape, a hard drive, a compact disk, and a digital versatile disk.

13. The system of claim 11 wherein graphical placement of the object representing the data establishes a logical association between the first physical media and the data.

14. The system of claim 13 wherein the object representing the data comprises one of the group consisting of: a file name, an icon representing a program type creating the data, and a directory folder containing the data.

15. The system of claim 11 wherein the data is saved to a virtual media prior to storing the data on the second physical media when the object representing the data is moved into the folder.

16. The system of claim 11 wherein the data is backed up in a backup operation selected from the group consisting of an incremental backup of the data, a differential backup of the data, a full backup of the data, and a copy operation of the data from the first physical media to the second physical media.

17. The system of claim 1 further comprising a backup catalog stored on the first computer, the backup catalog maintaining information about the data in a backup catalog, the backup catalog storing information including data configuration and type information, data location information, and data creation and backup time information.

18. A server computer comprising:
a backup process copying data from a first physical media to a second physical media;
a graphical user interface configured to display as a folder the second physical media into which the data is to be copied; and
a backup catalog storing icons within the folder representing virtual media into which the data is stored prior to copying to the second physical media, wherein the data is copied to the second physical media when an object representing the data is moved into the folder.

19. A server computer of claim 18 wherein the second physical media is coupled to a storage device, the server computer further comprising a network interface coupling the server computer to a storage device over a network.

20. The server computer of claim 19 wherein the backup catalog maintains information regarding the data including data configuration and type information, data location information, and data creation and backup time information.
